(19) United States
(12) Patent Application Publication
(10) Pub. No.: US 2006/0048021 A1
(43) Pub. Date: Mar. 2, 2006

(54) Signal control circuit and device mounted therewith

(75) Inventor: Toshihiro Miyamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/024,483

(22) Filed: Dec. 30, 2004

(30) Foreign Application Priority Data
Aug. 30, 2004 (JP) 2004-250741

(51) Int. Cl. G06F 11/00

(52) U.S. Cl. 714/701

(57) ABSTRACT

A signal control circuit for controlling a signal to be outputted from a signal processing circuit 11, of which a rise and a fall are repeated, includes pattern generation unit 20 for generating pattern information representing a certain pattern, and signal waveform adjusting unit (Q1, Q2, Q3, Q6) for changing at least one of rise time and fall time of the signal to be outputted from the signal processing circuit 11 in accordance with the pattern represented by the pattern information.

### BACKGROUND OF THE INVENTION

1. Field of the Present Invention

The present invention relates to a signal control circuit for controlling a signal that should be outputted from a signal processing circuit, of which a rise and a fall are repeated, and to a device mounted with the signal control circuit.

2. Description of the Related Art

There is a signal of which a rise and a fall are repeated as a clock signal as one of causes for an occurrence of release of unnecessary radio waves radiated from an electronic device. If a frequency of this type of signal is low, a wavelength is long, and therefore it is hard to be released as radio waves from an electronic device. As the frequency becomes higher, however, resonance occurs due to even a slight distance of wiring-round of a signal line, and it follows that the radio waves are released from the electronic device.

For example, a signal f(x) taking a pulse waveform contains higher harmonic waves, and there are many cases in which a problem is the release of the unnecessary radio waves due to the higher harmonic waves rather than this type of pulse signal itself. As known well, the pulse waveform is expressed in the following formula.

[Formula 1]

$$f ( x ) = {a}_{0} / 2 + {\sum }_{n = 1}^{∞} ( {a}_{n} cos nx + {b}_{n} sin nx )$$

It may be actually considered that an element “x” in this formula represents a period of the pulse waveform. Accordingly, it follows that the pulse waveform contains higher harmonic components having a frequency that is n-times (2, 3, . . . ) as large as the frequency of this pulse waveform. For instance, even when the frequency of the clock signal (pulse waveform signal) is 200 MHz, a wavelength of the n-th order higher harmonic wave is extremely short, and hence the radio waves can be sufficiently released in the case of even the slight distance of wiring-round of the signal line.

A preferable countermeasure against the radiation of the unnecessary radio waves is that a level itself of the radio waves released outside the device is reduced by decreasing a signal level of the pulse waveform signal used in the device and by strengthening a shield so that the unnecessary radio waves are not leaked outside the device. In fact, however, the countermeasure is limited in terms of a stable operation of the circuit and a cost thereof. Such being the case, there are proposed a variety of countermeasures in order to lessen an influence of the unnecessary radio waves upon an external device.

To begin with, a first example (refer to, e.g., Japanese Patent Application Laid-Open Publication No. 11-143572) is what is called as a so-called spread spectrum method, wherein the higher harmonic components contained in the clock signal are dispersed by changing the frequency (period) of the clock signal at random or periodically. With this dispersion, a level of each higher harmonic component is decreased, and a release level of the radio waves of the frequency, which is considered to adversely affect the device, is also reduced.

A second example (refer to, e.g., Japanese Patent Application Laid-Open Publication No. 2003-69403) is that on the occasion of electrification of the current taking a trapezoidal waveform with respect to an electric load, a load current is controlled so that rise time and fall time of the load current respectively become reference time. Under this control, the rise and the fall of the load current can be controlled to a predetermined characteristic, e.g., at a minimum change rate within an allowable range regardless of an impedance of the electric load, and noises (the release of the unnecessary radio waves) occurred due to the change in the load current can be reduced.

It is to be noted that there is proposed a clock generation circuit (e.g., Japanese Patent Application Laid-Open Publication No. 2003-15761) constructed not to reduce the release of the unnecessary radio waves occurred by a cause of the clock signal but to generate a clock signal that is hard to receive the influence of the noises caused by these unnecessary radio waves. In this clock generation circuit, the clock signal itself is made hard to receive the influence of the noises by changing timing of a rising edge and timing of a falling edge of the clock signal while keeping constant a frequency of the clock signal.

The first example described above is that there is changed the frequency (period) of the clock signal of which the rise and the fall are periodically repeated, and therefore does not show any consideration about a signal of which the rise and the fall are repeated at arbitrary timing.

Further, in the second example described above, if the impedance of the electric load changes to a small degree, the rising waveform and the falling waveform of the load current become substantially uniform waveforms determined by reference rise time, reference fall time, a current level and so on. In this case, the higher harmonic components determined by substantially the uniform waveforms of the load current might come to a level possible of adversely affecting other circuits within the device.

### SUMMARY OF THE INVENTION

The present invention was devised to solve the problems inherent in the prior arts described above, and aims at providing a signal control circuit capable of reducing a release of unnecessary radio waves due to a signal of which a rise and a fall are repeated irrespective of whether it is periodic or not.

A signal control circuit according to the present invention is a signal control circuit for controlling a signal to be outputted from a signal processing circuit, of which a rise and a fall are repeated, comprising pattern generation unit generating pattern information representing a certain pattern, and signal waveform adjusting unit changing at least one of rise time and fall time of the signal to be outputted from the signal processing circuit in accordance with the pattern represented by the pattern information.

With this construction, at least one of the rise time and the fall time of the signal to be outputted from the signal processing circuit changes according to a certain pattern. Therefore, the waveform of the signal of which the rise and the fall are repeated changes in accordance with the pattern, and it follows that higher harmonic components contained in the signal get dispersed.

The pattern can be arbitrarily set, and may be a pattern that changes substantially at random and may also be a pattern that changes periodically. Further, the signal control circuit may be a circuit constructed to resultantly change at least one of the rise time and the fall time of the signal to be outputted from the signal processing circuit, and may be constructed to act on the signal inputted to the signal processing circuit and may also be constructed to act on the signal processing circuit itself. Moreover, this signal control circuit may be a circuit included in the signal processing circuit itself so as to build up the signal processing circuit, and may also be constructed independently of the signal processing circuit so as to control the signal processing circuit.

If the signal to be outputted from the signal control circuit is a clock signal of which the rise and the fall are periodically repeated, at least one of rise time and fall time of the clock signal can be changed in accordance with the pattern while keeping constant a period of the clock signal.

Further, in the signal control circuit according to the present invention, the signal waveform adjusting unit includes unit controlling an output impedance of the signal processing circuit in accordance with the pattern represented by the pattern information.

With this configuration, the output impedance of the signal processing circuit changes according to a certain pattern. It therefore follows that a time constant determined by the output impedance and a load capacity of the signal processing circuit changes in accordance with the pattern, and as a result the rise time and the fall time of the signal outputted from the signal processing circuit changes in accordance with the pattern.

Further, the signal control circuit according to the present invention can take such a construction that the signal waveform adjusting unit includes unit controlling an output current of the signal processing circuit in accordance with the pattern represented by the pattern information. With this construction, the output current of the signal processing circuit changes in accordance with a certain pattern. It therefore follows that charging/discharging time with respect to a load capacity of the signal processing circuit changes in accordance with the pattern, and as a result the rise time and the fall time of the signal outputted from the signal processing circuit changes in accordance with the pattern.

Moreover, in the signal control circuit according to the present invention, the signal waveform adjusting unit may include first and second transistors, having an common input terminal to each other and an common output terminal to each other, building up a complementary switch circuit capable of controlling a conductive state and a cut-off state alternately, and third and fourth transistors for controlling in common respective bias signals of the first and second transistors along with bias signals of the third and fourth transistors themselves, biases of the third and fourth transistors may be set based on the pattern information, and, irrespective of setting the biases based on the pattern information, when an input signal to the common input terminal is equal to or higher than a predetermined reference level, the first transistor comes to the conductive state, while the second transistor comes to the cut-off state, and, when the input signal to the common input terminal is equal to or lower than the predetermined reference level, the first transistor comes to the cut-off state, while the second transistor comes to the conductive state.

With this construction, the biases of the first and second transistors building up the complementary switch circuit are set based on the pattern information through the third and fourth transistors. On the other hand, the conductive state and the cut-off state of the first and second transistors are determined depending on whether or not the input signal is equal to or higher than the predetermined reference level. Accordingly, when the common input terminal receives an input of a periodic signal of which a low electric potential equal to or lower than the reference level and a high electric potential equal to or higher than the reference level are repeated, there is kept a period with which an output signal outputted from the common output terminal repeatedly transits between the low electric potential and the high electric potential. On the other hand, it follows that the rise time for which the periodic signal transits to the high electric potential from the low electric potential and the fall time for which the periodic signal transits to the low electric potential from the high electric potential, depend on the pattern information.

A semiconductor device according to the present invention may take a construction including a signal processing circuit and any of the signal control circuits described above.

In the semiconductor device having this construction, at least one of the rise time and the fall time of the signal to be outputted from the signal processing circuit changes in accordance with a certain pattern. It therefore follows that the waveform of the signal with the repetition of the rise and the fall thereof changes in accordance with the pattern, and higher harmonic components contained in the signal get dispersed. Thus, since the higher harmonic components generated in the semiconductor device get dispersed, energy of radio waves that can be radiated from the semiconductor device due to the higher harmonic components also disperses, and there is decreased a level of the radio waves due to the individual higher harmonic components. It is noted that the semiconductor device may further comprise unit generating a periodic signal of which a signal level equal to or higher than a predetermined reference level and a signal level equal to or lower than the predetermined reference level are repeated in connection with the signal waveform adjusting unit.

Moreover, an electronic device according to the present invention may such a construction as to be mounted with the semiconductor device.

In the thus constructed electronic device, as a result of decreasing the level of the radio waves radiated from the semiconductor device, a level of the radio waves radiated from the electronic device is also reduced.

In the signal control circuit according to the present invention, since the higher harmonic components contained in the signal are dispersed by changing at least one of the rise time and the fall time of the signal to be outputted from the signal processing circuit in accordance with a certain pattern, the energy of the radio waves that can be generated due to the higher harmonic components also disperses, and there is decreased the level of the radio waves due to the individual higher harmonic components. It is therefore possible to reduce the release of the unnecessary radio waves due to the signal of which the rise and the fall are repeated irrespective of whether it is periodic or not.

### BRIEF DESCRIPTION OF THE DRAWINGS

FIG. 1 is a block diagram shows a constructive example (part 1) of an output stage of a semiconductor device formed with a signal control circuit according to one embodiment of the present invention;

FIG. 2 is a block diagram shows a constructive example (part 2) of the output stage of the semiconductor device formed with the signal control circuit according to one embodiment of the present invention;

FIG. 3 is a circuit diagram shows a constructive example (part 1) of a pattern generation circuit;

FIG. 4 is a circuit diagram shows a constructive example (part 1) of a driver cell;

FIG. 5 is a circuit diagram shows a constructive example (part 2) of the pattern generation circuit;

FIG. 6 is a diagram shows an output state of the pattern generation circuit shown in FIG. 5;

FIG. 7 is a circuit diagram shows a constructive example (part 2) of the driver cell;

FIG. 8 is a circuit diagram shows a constructive example (part 3) of the driver cell; and

FIG. 9 is a waveform diagram shows a waveform of an output signal from the driver cell shown in FIG. 8.

### DESCRIPTION OF THE PREFERRED EMBODIMENTS

Embodiments of the present invention will hereinafter be described with reference to the drawings.

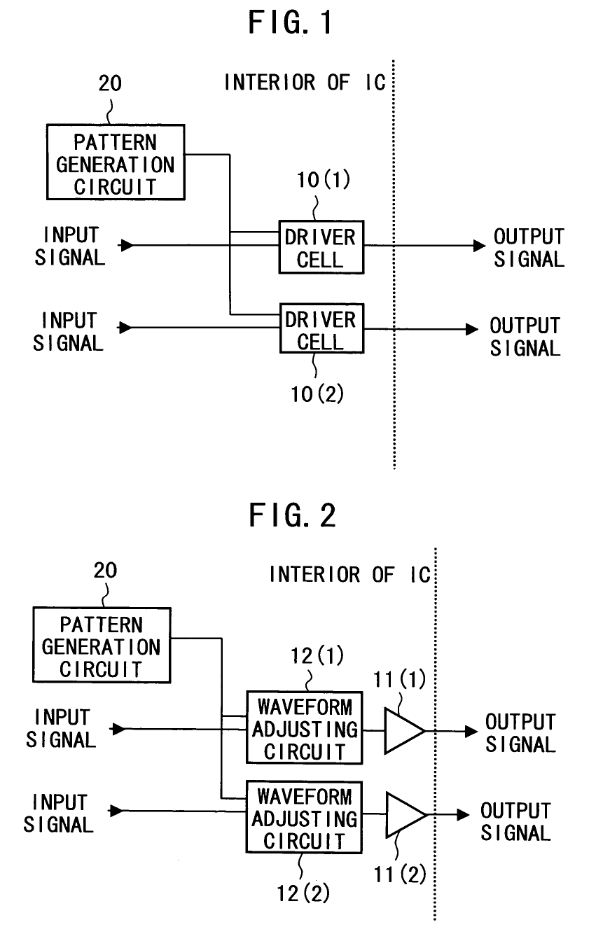

A semiconductor device (IC) mounted with a signal processing circuit according to the embodiment of the present invention is constructed as shown in, e.g., FIG. 1. FIG. 1 shows a construction of a data or signal output stage in the semiconductor device (IC) . This semiconductor device (IC) can be mounted on an information electronic device such as a personal computer, etc., a communication device such as a cellular phone, etc., and various other types of electronic devices.

In FIG. 1, driver cells 10(1), 10(2) (a signal processing circuit) are built up in the interior of the semiconductor device (IC) . Each of the driver cells 10(1), 10(2) generates an output signal by processing an input signal. This output signal is supplied to other circuit of the electronic device mounted with the semiconductor device (IC) from an output terminal of this semiconductor device (IC). The driver cells 10(1), 10(2) may be those interposed in a digital data line and may also be those interposed in an analog signal line.

Further, a pattern generation circuit 20 is built up in the interior of the semiconductor device (IC). The pattern generation circuit 20 generates pattern information representing a predetermined pattern, and supplies the pattern information to each of the driver cells 10(1), 10(2). Each of the driver cells 10(1), 10(2) includes an element for controlling rise time and fall time of the output signal that should be generated. This element controls the rise time and the fall time of the output signal on the basis of the pattern information.

The output stage in the semiconductor device (IC) can also be built up as shown in FIG. 2. In this example, waveform adjusting circuits 12(1), 12(2) are provided for respective driver cells 11(1), 11(2) together with the pattern generation circuit 20 within the semiconductor device (IC). The respective waveform adjusting circuits 12(1), 12(2) adjust waveforms of input signals to the driver cells 11(1), 11(2) so as to adjust rise time and fall time of output signals that should be outputted from the corresponding driver cells 11(1), 11(2) on the basis of the pattern information given from the pattern generation circuit 20.

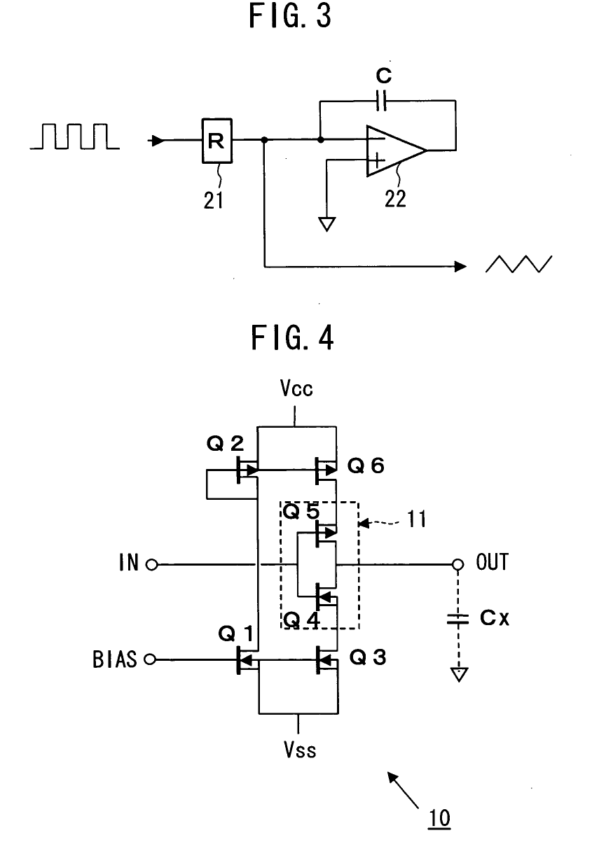

The pattern generation circuit 20 can also be constructed as shown in FIG. 3. In FIG. 3, the pattern generation circuit 20 is a mirror integrator constructed of a resistor 21, a differential amplifier 22 and a capacitor C. When a rectangular pulse signal is inputted, a sawtooth waveform signal, which changes with a period corresponding to a cycle period of the rectangular pulse signal, is outputted from an output terminal of the differential amplifier 20. The pattern generation circuit 20 outputs, as pattern information, the sawtooth waveform signal representing a pattern that thus changes periodically in a sawtooth waveform.

When the pattern generation circuit 20 is configured as shown in FIG. 3, the driver cells 10(1), 10(2) (the reference numeral 10 will hereinafter be used for generically terming these driver cells) in FIG. 1 can be constructed as illustrated in FIG. 4.

The driver cell 10 shown in FIG. 4 is a current limiting type inverter (current stubbed inverter). In this current limiting type inverter, an inverter 11 is constructed of an N-channel MOS transistor Q4 and a P-channel MOS transistor Q5, wherein when a signal is inputted to an input terminal IN, a signal of which a signal waveform has been inverted is outputted to an output terminal from an output terminal OUT. An element excluding the inverter 11 in the driver cell 10 is an element for controlling the rise time and the fall time of the output signal that should be generated by the inverter 11.

This element is constructed of N-channel MOS transistors Q1, Q3 and P-channel MOS transistors Q2, Q6. Note that the N-channel MOS transistor and the P-channel MOS transistor will hereinafter simply be called transistors. The transistors Q2 and Q1 are connected in series between a power supply line Vcc and a predetermined potential line Vss (e.g., an earth line). The transistor Q6, the transistors Q5, Q4 configuring the inverter 11 and the transistor Q3 are also connected in series between the power supply line Vcc and the potential line Vss. The transistors Q3, Q6 build up a mirror circuit and are respectively supplied with the same gate voltages as those to the transistors Q1, Q2. The sawtooth waveform signal (a control voltage (BIAS)) outputted as the pattern information is, as described above, applied to a gate of the transistor Q1 from the pattern generation circuit 20.

In the thus-constructed driver cell 10, when a certain control voltage (BIAS) is applied to the gate of the transistor Q1, the control voltage and a current i corresponding to a mutual conductance gm flow to a drain of the transistor Q1. A gate of the transistor Q2 is thereby biased at a voltage equilibrating with the flow of the current i corresponding to the mutual conductance gm of the transistor Q2. The transistors Q3, Q6 serving as the mirror circuit to the transistors Q1, Q2 are respectively supplied with the same gate voltages as those to the transistors Q1, Q2, and hence the same current i as the aforementioned current flows thereto.

When the output (OUT) of the inverter 11 is “1” (Vcc), the transistor Q5 is ON, while the transistor Q4 is OFF. When the output thereof is “0”, the transistor Q4 is ON, while the transistor Q5 is OFF. The transistors Q4, Q5 perform the ON/OFF operations in accordance with an input signal (IN), and a rise (01) and a fall (10) of the output (OUT) of the inverter 11 are repeated in accordance with the ON/OFF operations of these transistors Q4, Q5. When the transistor Q5 becomes ON in the process of these ON/OFF operations of the transistors Q4, Q5, the output current is so controlled by the transistor Q6 as to become the current i. When the transistor Q4 becomes ON, the output current is so controlled by the transistor Q3 as to become the current i. A charging/discharging current for a load capacity Cx is thereby limited to the current i. Namely, a period of charging/discharging time for the load capacity Cx is determined by the current i.

When the control voltage (BIAS) applied to the gate of the transistor Q1 changes in the sawtooth waveform (periodically) due to the sawtooth waveform signal from the pattern generation circuit 20, the current i changes according to this pattern (sawtooth waveform). With this change, it follows that the charging/discharging time for the load capacity CX changes periodically (in the sawtooth waveform) according to the changing current i, and a rise time and a fall time of the signal, which appear in the output (OUT) of the inverter 11, periodically change in accordance with a change pattern of the current i.

Thus, when the rise time and the fall time of the output signal from the driver cell 10 periodically change, higher harmonic components contained in the output signal get dispersed, energy of radio waves generated due to the higher harmonic components also disperses, and there is decreased a level of the radio waves due to the individual higher harmonic components. It is therefore possible to decrease the level of the unnecessary radio waves released from the semiconductor device (IC) on the basis of the fluctuations (the rise and the fall) in the output signal from the driver cell 10.

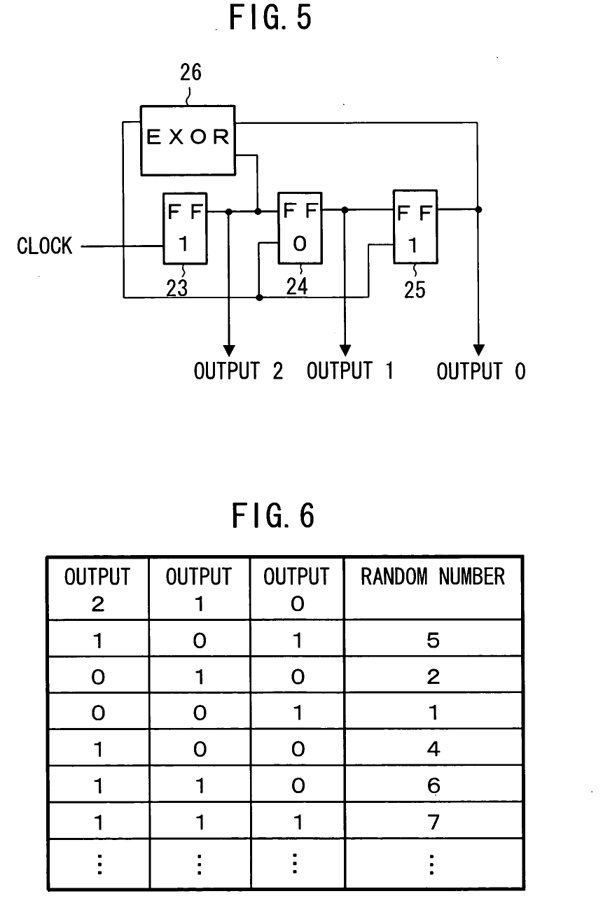

The pattern generation circuit 20 can be also constructed as shown in FIG. 5. In this example, the pattern information digitally representing the pattern, which changes at random, is generated.

In FIG. 5, the pattern generation circuit 20 is a LFSR (Linear Feedback Shift Register) constructed of flip-flops (FFs) 23, 24, 25 and an exclusive OR circuit (EXOR) 26. The thus constructed pattern generation circuit 20 functions as a random number generator, wherein outputs 0, 1, 2 of the flip-flops 25, 24, 23 change as shown in, e.g., FIG. 6 each time a clock is given to an input of the flip-flop 23. FIG. 6 shows values of the outputs 0, 1, 2 that change each time the clock is given in a case where initial values “1”, “0”, “1” are set in the flip-clops 23, 24, 25. In this case, the numbers, which are expressed in binary numbers with the outputs 0, 1, 2 used as respective digits, change substantially at random (random numbers). The pattern generation circuit 20 outputs, as the pattern information, the values of the outputs 0, 1, 2 that thus change at random.

Note that the initial values set in the respective flip-flops 23, 24, 25 can be arbitrarily set without being limited to “1”, “0”, “1”. Further, the values set in the flip-flops 23, 24, 25 can be also updated based on bits of part of, for example, binarized date information at arbitrary timing.

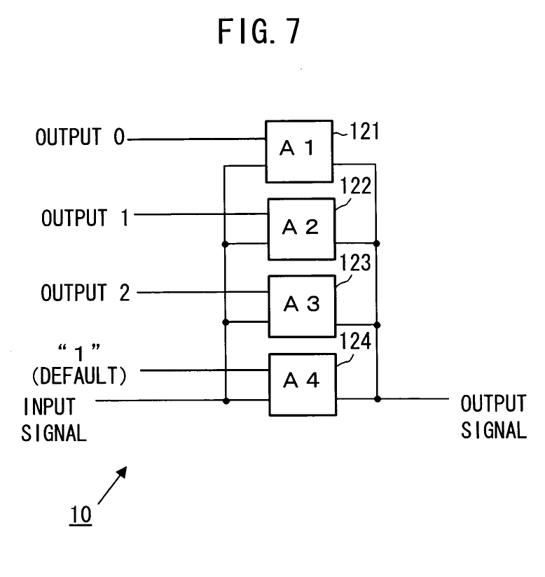

When the pattern generation circuit 20 is constructed as explained above (see FIG. 5), each driver cell 10 in FIG. 1 can be built up as illustrated in FIG. 7.

In the driver cell 10 shown in FIG. 7, input signals are given in parallel to four pieces of AND gates 121, 122, 123, 124, a bit of the output 0 of the pattern generation circuit 20 is inputted as a gate signal of the AND gate 121, a bit of the output 1 of the pattern generation circuit 20 is inputted as a gate signal of the AND gate 122, and a bit of the output 2 of the pattern generation circuit 20 is inputted as a gate signal of the AND gate 123, respectively. Further, a bit “1” (a default value) is always inputted as a gate signal of the AND gate 124. Outputs of the four AND gates 121, 122, 123, 124 are OR-connected, whereby a single output signal is outputted.

Controlled in the thus-built-up driver cell 10 is the number of the AND gates becoming an allowable state according to bit values of the outputs 0, 1, 2 of the pattern generation circuit 20. As the number of the AND gates becoming the allowable state increases, an output impedance of the driver cell 10 decreases, and a time constant determined by the load capacity is reduced, with the result that the rise time and the fall time of the output signal become shorter (a steeper change). While on the other hand, as the number of the AND gates becoming the allowable state decreases, the output impedance of the driver cell 10 rises, and the time constant determined by the load capacity is increased, with the result that the rise time and the fall time of the output signal become longer (a more sluggish change). Note that if the bits of the outputs 0, 1, 2 of the pattern generation circuit 20 are all “0”, only the AND gate 124 comes to the allowable state and functions as a buffer. In this case, an output signal corresponding to the input signal is obtained from the AND gate 124.

As described above, the values of the outputs 0, 1, 2 of the pattern generation circuit 20 change at random, and it therefore follows that the number of the AND gates becoming the allowable state is controlled at random in the driver cell 10. As a result, the output impedance of the driver cell 10 is controlled at random, and the rise time and the fall time of the output signal change at random.

Thus, when the rise time and the fall time of the output signal from the driver cell 10 change at random, the higher harmonic components contained in the output signal get dispersed, the energy of the radio waves generated due to the higher harmonic components also disperses, and there is decreased the level of the radio waves due to the individual higher harmonic components. It is therefore possible to decrease the level of the unnecessary radio waves released from the semiconductor device (IC) on the basis of the fluctuations in the output signal from the driver cell 10.

As described above, in the respective examples (which are the example shown in FIGS. 3 and 4 and the example shown in FIGS. 5 through 7), the output current and the output impedance of the driver cell 10 are controlled periodically or at random, and, when the output signal of the driver cell 10 rises and falls, the rise time and the fall time thereof become those corresponding to the output current and the output impedance at that point of time. Accordingly, even when the output signal is a signal of which the rise and the fall are periodically repeated as the clock signal, etc. or a signal of which the rise and the fall are repeated at the arbitrary timing as the data, the rise time and the fall time thereof come to change.

Note that an allowable change width of the rise time and the fall time that should be controlled is determined based on a utilizing purpose, etc. of the signal of which the rise time and the fall time should be controlled.

Given next is an explanation of an example of changing the rise time and fall time of the signal without any change in period of the signal that periodically repeats the rise and the fall thereof as the clock signal, etc..

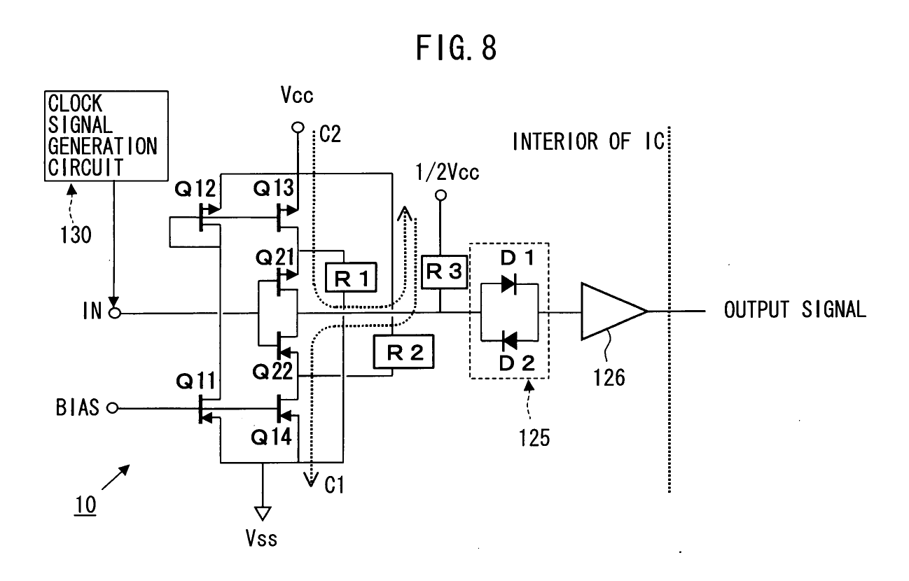

In this case, the driver cell 10 can be built up as shown in FIG. 8. The driver cell 10 shown in FIG. 8 also involves using the current limiting type inverter. To be specific, a transistor Q12 (P-channel) and a transistor Q11 (N-channel) are connected in series between the power supply line Vcc and the predetermined potential line Vss (e.g., the earth line) . A transistor Q13 (P-channel), transistors Q21 (P-channel) and Q22 (N-channel) that configure the inverter and a transistor Q14 (N-channel) are connected in series therebetween. Further, a gate of the transistor Q12 is connected to a gate of the transistor Q13, a gate of the transistor Q11 is connected to a gate of the transistor Q14, wherein the pattern information (e.g., the control voltage BIAS taking the sawtooth waveform etc.) from the pattern generation circuit 20 is applied to the gate of the transistor Q11.

Moreover, a resistor R1 is connected between the predetermined potential line Vss and a connecting point between a source of the transistor Q21 and a drain of the transistor Q13, and a resistor R2 is connected between the power source line Vcc and a connecting point between a source of the transistor Q22 and a drain of the transistor Q14. A clipper circuit 125 constructed of diodes D1, D2 is connected to an output terminal of the inverter (Q21, Q22), and a buffer (amplifier) 126 is connected to an output terminal of the clipper circuit 125. A signal outputted from the inverter is, through a level control process in the clipper circuit 125 and an amplifying process in the buffer circuit 126, thereby outputted as an output signal from the semiconductor device (IC). Further, the output terminal of the inverter (Q21, Q22) is connected via a resistor R3 to a potential line ½ Vcc where the voltage becomes half (½ Vcc) the power source voltage Vcc.

A clock signal of which the rise and the fall periodically repeat centered on a central voltage ½ Vcc between the power source voltage Vcc and the earth voltage Vss (=0V), is inputted from a clock signal generation circuit 130 to an input terminal (IN) of the inverter in the thus-constructed driver cell 10. Then, in a state of keeping constant a period from timing of becoming the central voltage ½ Vcc up to the timing of becoming the central voltage ½ Vcc next time while maintaining the central voltage at ½ Vcc, the clock signal is amplitude-modulated based on the pattern information (e.g., the control voltage taking the sawtooth waveform, etc.) given from the pattern generation circuit 20. A signal obtained by this amplitude modulation is regulated at a fixed level by the clipper circuit 125 and is further amplified to become a desired level by the buffer 126.

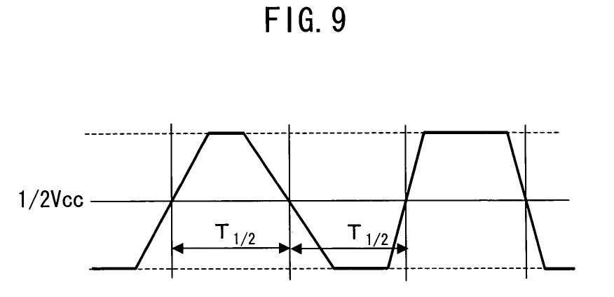

Thus, the level of the signal obtained by the amplitude modulation in the state of keeping constant the period from the timing of becoming the central voltage ½ Vcc up to the timing of becoming the central voltage ½ Vcc next time, is regulated at the fixed level, and hence it follows that there is acquired the output signal of which the rise and the fall get steeper (the shorter rise time and the shorter fall time) with the larger amplitude (level) of the signal obtained by the amplitude modulation, and of which the rise and the fall get more sluggish (the longer rise time and the longer fall time) with the smaller amplitude of the signal obtained by the amplitude modulation. Specifically, as shown in FIG. 9, there is obtained the output signal (clock signal), of a desired output level, of which the rise time and the fall time change in a state where a period T1/2 from the timing of becoming the central voltage ½ Vcc up to the timing of becoming the central voltage ½ Vcc next time is kept constant, i.e., in a state where the periodic cycle is kept constant. Further, specific operations become as follows.

When the input signal is equal to or larger than ½ Vcc, the transistor Q22 (N-channel) of the inverter becomes ON, and the current flows from the potential line ½ Vcc via the resistor R3, the drain and the source of the transistor Q22 and the transistor Q14 to the earth line Vss (=0V) (see an arrowhead C1 of a broken line in FIG. 8). At this time, a voltage corresponding to that current appears in the resistor R3. While on the other hand, when the input signal is smaller than ½ Vcc, the transistor Q21 (P-channel) of the inverter becomes ON, and the current flows from the power source line Vcc via the transistor Q13, the source and the drain of the transistor Q21 and the resistor R3 to the potential line ½ Vcc (see an arrowhead C2 of a broken line in FIG. 8). At this time, a voltage corresponding to that current appears in the resistor R3.

On the other hand, in the current limiting type inverter (Q11, Q12, Q13, Q14, Q21, Q22), similarly to the aforementioned example (see FIG. 4), the mutual conductance gm of the transistors Q13, Q14 changes corresponding to the control voltage (BIAS) applied to the gate of the transistor Q11. Namely, when a certain control voltage (BIAS) is applied to a gate of the transistor Q11, the current i corresponding to the control voltage and the mutual conductance gm flows to a drain of the transistor Q11. A gate of the transistor Q12 is thereby biased at a voltage equilibrating with the flow of the current i corresponding to the mutual conductance gm of the transistor Q12. The transistors Q13, Q16 serving as the mirror circuit to the transistors Q11, Q12 are respectively supplied with the same gate voltages as those to the transistors Q11, Q12, and hence the same current i as the aforementioned current flows thereto.

Then, source voltages of the transistors Q21, Q22 configuring the inverter are generated in the resistors R1, R2 by a current determined by the control voltage (BIAS) and the mutual inductance of the transistors Q13, Q14.

The current outputted from each of the transistors Q21, Q22 depends on the mutual conductance gm of the transistors Q21, Q22 themselves and on the voltage of the clock signal, and further the mutual conductance gm of the transistors Q21, Q22 depends on the source voltages generated in the resistors R1, R2. Therefore, as a result, the voltage appearing in the resistor R3 due to the output currents of the transistors Q21, Q22 depends on the control voltage (BIAS). In this circuitry, the mutual conductance gm of the transistors Q21, Q22 is controlled by the control voltage (BIAS) through the transistors Q11, Q12 and the transistors Q14, Q13 defined as the mirror circuit. As a consequence, the rise time and the fall time of the output signals of transistors Q11, Q12 change according to the control voltage (BIAS). On the other hand, timing at which the transistors Q21 and Q22 perform ON/OFF switchover is determined independently of the control voltage (BIAS) as the timing at which the input signal (clock signal) comes to the central voltage ½ Vcc.

Accordingly, the voltage waveform appearing in the resistor R3, irrespective of whether the control voltage (BIAS) fluctuates or not, remains fixed for the period from the timing of becoming the central voltage ½ Vcc up to the timing of becoming the central voltage ½ Vcc next time in the same way as in the case of the input signal (clock signal), and the amplitude of the voltage waveform becomes an amplitude corresponding to the control voltage (BIAS). Then, the amplitude of the voltage waveform appearing in the resistor R3 is regulated at a fixed level by the clipper circuit 125, and a signal outputted from the clipper circuit 125 is amplified by the buffer 126, thereby generating an output voltage. As a result, the rise time and the fall time of the output voltage become those corresponding to the amplitude of the signal before the level regulation is done by the clipper circuit 125, i.e., corresponding to the control voltage (BIAS) . Hence, the control voltage (BIAS) changes according to the pattern (e.g., the sawtooth waveform, the random waveform, etc.) given from the pattern generation circuit 20, whereby the rise time and the fall time of the output signal, as shown in FIG. 9, change in the state where the period T1/2 from the timing of becoming the central voltage ½ Vcc up to the timing of becoming the central voltage ½ Vcc next time is kept constant, i.e., in the state where the periodic cycle is kept constant.

Thus, the rise time and the fall time of the output signal from the driver cell 10 change according to the pattern represented by the pattern information given from the pattern generation circuit 20 in the state where the periodic cycle is kept constant, and hence, as in the respective examples described above, the level of the unnecessary radio waves released from the semiconductor device (IC) can be reduced.

Note that both of the rise time and the fall time of the output signal that should be outputted from the driver cell 10 change in the respective examples described above, however, any one of the rise time and the fall time may also changes.

Moreover, a signal processing circuit for inversely generating a periodic pulse signal by synthesizing a plurality of frequency components (corresponding to the higher harmonic components), is controlled in a way that changes a combination of the higher harmonic components that should be synthesized in accordance with a certain pattern, whereby the rise time and the fall time of the pulse signal outputted from the signal processing circuit can be changed based on the pattern.

### INDUSTRIAL APPLICABILITY

The signal processing circuit according to the present invention exhibits an effect of being capable of reducing the release of the unnecessary radio waves due to the signal of which the rise and the fall are repeated irrespective of whether it is periodic or not, and is useful as the signal control circuit for controlling the signal to be outputted from the signal processing circuit, of which the rise and the fall are repeated.

What is claimed is:

1. A signal control circuit controlling a signal to be outputted from a signal processing circuit, of which a rise and a fall are repeated, comprising:
a pattern generation unit generating pattern information representing a certain pattern; and
a signal waveform adjusting unit changing at least one of rise time and fall time of the signal to be outputted from the signal processing circuit in accordance with the pattern represented by the pattern information.

2. The signal control circuit according to claim 1, wherein the pattern generation unit generates the pattern information representing the pattern that changes substantially at random.

3. The signal control circuit according to claim 1, wherein the pattern generation unit generates the pattern information representing the pattern that changes periodically.

4. The signal control circuit according to claim 1, wherein the signal to be outputted from the signal processing circuit is a clock signal.

5. The signal control circuit according to claim 4, wherein the signal waveform adjusting unit changes at least one of rise time and fall time of the clock signal in accordance with the pattern represented by the pattern information while keeping a period of the clock signal.

6. The signal control circuit according to claim 1, wherein the signal waveform adjusting unit includes unit controlling an output impedance of the signal processing circuit in accordance with the pattern represented by the pattern information.

7. The signal control circuit according to claim 1, wherein the signal waveform adjusting unit includes unit controlling an output current of the signal processing circuit in accordance with the pattern represented by the pattern information.

8. The signal control circuit according to claim 1, the signal waveform adjusting unit further comprising:
a first transistor and a second transistor, having an common input terminal to each other and an common output terminal to each other, building up a complementary switch circuit capable of controlling a conductive state and a cut-off state alternately; and
a third transistor and a fourth transistor for controlling in common respective bias signals of the first transistor and the second transistor along with bias signals of the third transistor and the fourth transistor themselves, wherein
biases of the third and fourth transistors are set based on the pattern information, and
irrespective of setting the biases based on the pattern information, when an input signal to the common input terminal is equal to or higher than a predetermined reference level, the first transistor comes to the conductive state, while the second transistor comes to the cut-off state, and, when the input signal to the common input terminal is equal to or lower than the predetermined reference level, the first transistor comes to the cut-off state, while the second transistor comes to the conductive state.

9. A semiconductor device comprising a signal processing circuit and the signal control circuit according to claim 1.

10. A semiconductor device according to claim 9, further comprising unit generating a periodic signal of which a signal level equal to or higher than a predetermined reference level and a signal level equal to or lower than the predetermined reference level are repeated in connection with the signal waveform adjusting unit.

11. An electronic device mounted with the semiconductor device according to claim 10.

12. An electronic device mounted with the signal control circuit according to claim 1.
